(19) United States
(12) Patent Application Publication
(10) Pub. No.: US 2024/0202759 A1
(43) Pub. Date: Jun. 20, 2024

(54) CACHING SCHEME FOR REAL-TIME DELIVERY OF OPTIMAL VEHICLE DATA

(71) Applicant: RunMyLease Inc, Watertown, MA (US)

(72) Inventors: Alexey Plokhikh, West Newton, MA (US); Inesa Plokhikh, West Newton, MA (US); Jared Neves, Plympton, MA (US)

(21) Appl. No.: 18/430,186

(22) Filed: Feb. 1, 2024

Related U.S. Application Data
(63) Continuation of application No. 17/475,438, filed on Sep. 15, 2021.

(51) Int. Cl. G06Q 30/0201; G06F 16/2453; G06Q 30/0207; G06Q 30/0283; G06Q 30/0601

(52) U.S. Cl. CPC G06Q 30/0206; G06F 16/24539; G06Q 30/0207; G06Q 30/0283; G06Q 30/0611

(57) ABSTRACT

In a caching scheme for real-time delivery of vehicle data, an application host receives a request for the vehicle data for a specific vehicle to be displayed on a website, where the vehicle data includes optimal price data for the specific vehicleThe application host retrieves a response to the request from an application cache or a database cache, if the response exists there. If not, then the application host calculates the optimal price data by determining whether meta data for the specific vehicle matches parameter values in one or more pricing rules. If so, the application host identifies the pricing rule that has the highest number of parameter values. The optimal price data for the specific vehicle is then calculated by applying the formula in this pricing rule and returned in the response.

### CROSS-REFERENCE TO RELATED APPLICATION

This application is a continuation of U.S. patent application Ser. No. 17/475,438, filed Sep. 15, 2021, titled “REAL-TIME DELIVERY OF OPTIMAL VEHICLE PRICING DATA USING A CACHING SCHEME.” The disclosure of this application is hereby incorporated by reference in its entirety.

### BACKGROUND OF THE INVENTION

Conventional systems lack integration with the dealer website for the receiving of real-time vehicle pricing requests and the delivery of the requested pricing information. Instead, in order to provide the optimal price to customers, dealers are required to manually apply discounts not otherwise applicable through conventional systems and to communicate the optimal price through time delayed means, such as email, telephone, or a subsequent in-person visit to the dealership by the customer. Conventional systems lack features which allow dealers to respond to customer requests for optimal vehicle pricing in real-time through the dealer website. For example, conventional systems limit their pricing features to allow only pricing of each vehicle individually or applies the same discount to all vehicles in inventory. In practice, because the pricing of individual vehicles is very time consuming, dealers often opt to apply one pricing discount to all the vehicles in their inventories. With this limitation, even when lower prices are available, these prices are not shown to potential buyers on the dealer website.

### SUMMARY OF THE EMBODIMENTS

In accordance with one embodiment, a method for real-time delivery of vehicle data, includes: receiving, by an application host, from a browser displaying a website for a dealer of a plurality of vehicles, a request for vehicle data for a specific vehicle to be displayed on the website, the vehicle data including optimal price data for the specific vehicle; determining, by the application host, whether a response comprising the optimal price data for the specific vehicle exists in an application cache; in response to determining that the response exists in the application cache, retrieving the response from the application cache by the application host and sending the response to the browser for display of the optimal price data on the website; in response to determining that the response does not exist in the application cache, determining whether the optimal price data for the specific vehicle exists in a database cache of a database storing meta data for the plurality of vehicles; in response to determining that the optimal price data for the specific vehicle exists in the database cache, retrieving the optimal price data from the database cache by the application host, creating the response with the optimal price data, sending the response to the browser for display of the optimal price data on the website, and storing the response in the application cache for subsequent requests; and in response to determining that the optimal price data does not exist in the database cache: determining that meta data for the specific vehicle fails to match all parameter values included in at least one of a plurality of pricing rules configured by the dealer, where each pricing rule further includes a formula for calculating a price; determining whether the meta data for the specific vehicle matches less than all of the parameter values included in the plurality of the pricing rules; and in response to determining that the meta data for the specific vehicle matches less than all of the parameter values included in at least one of the plurality of pricing rules: identifying a given pricing rule of the plurality of pricing rules that includes a highest number of parameter values matching the meta data for the specific vehicle; calculating the optimal price data for the specific vehicle by applying the formula included in the given pricing rule to the specific vehicle; creating the response including the optimal price data for the specific vehicle by the application host; sending the response to the browser for display of the optimal price data on the website; and storing the response in the application cache for the subsequent requests.

In accordance with another embodiment, a non-transitory computer readable medium including computer readable program code embodied therein, where when executed by a processor causes the processor to: receive, from a browser displaying a website for a dealer of a plurality of vehicles, a request for vehicle data for a specific vehicle to be displayed on the website, the vehicle data including optimal price data for the specific vehicle; determine whether a response including the optimal price data for the specific vehicle exists in an application cache; in response to determining that the response exists in the application cache, retrieve the response from the application cache and send the response to the browser for display of the optimal data on the website; in response to determining that the response does not exist in the application cache, determine whether the optimal price data for the specific vehicle exists in a database storing meta data for the plurality of vehicles; in response to determining that the optimal price data for the specific vehicle exists in the database cache, retrieve the optimal price data from the database cache, create the response with the optimal price data, send the response to the browser for display of the optimal price data on the website, and store the response in the application cache for subsequent requests; and in response to determining that the optimal price data does not exist in the database cache: determine that meta data for the specific vehicle fails to match all parameter values included in at least one of a plurality of pricing rules, where each pricing rule further includes a formula for calculating a price; determine whether the meta data for the specific vehicle matches less than all of the parameter values included in the plurality of the pricing rules; and in response to determining that the meta data for the specific vehicle matches less than all of the parameter values included in at least one of the plurality of pricing rules: identify a given pricing rule of the plurality of pricing rules that includes a highest number of parameter values matching the meta data for the specific vehicle; calculate the optimal price data for the specific vehicle by applying the formula included in the given pricing rule to the specific vehicle; create the response including the optimal price data for the specific vehicle by the application host; send the response to the browser for display of the optimal price data on the website; and store the response in the application cache for the subsequent requests.

In accordance with another embodiment, a system, including: an application host including a processor, an application cache, and a non-transitory computer readable medium including computer readable program code embodied therein, where when executed by the processor causes the processor to: receive, from a browser displaying a website for a dealer of a plurality of vehicles, a request for vehicle data for a specific vehicle to be displayed on the website, the vehicle data including optimal price data for the specific vehicle; determine whether a response including the optimal price data for the specific vehicle exists in an application cache; in response to determining that the response exists in the application cache, retrieve the response from the application cache and send the response to the browser for display of the optimal data on the website; in response to determining that the response does not exist in the application cache, determine whether the optimal price data for the specific vehicle exists in a database cache of a database storing meta data for the plurality of vehicles; in response to determining that the optimal price data for the specific vehicle exists in the database cache, retrieve the optimal price data from the database cache, create the response with the optimal price data, send the response to the browser for display of the optimal price data on the website, and store the response in the application cache for subsequent requests; and in response to determining that the optimal price data does not exist in the database cache: determine that meta data for the specific vehicle fails to match all parameter values included in at least one of a plurality of pricing rules, where each pricing rule further includes a formula for calculating a price; determine whether the meta data for the specific vehicle matches less than all of the parameter values included in the plurality of the pricing rules; and identify a given pricing rule of the plurality of pricing rules that includes a highest number of parameter values matching the meta data for the specific vehicle; in response to determining that the meta data for the specific vehicle matches less than all of the parameter values included in at least one of the plurality of pricing rules: calculate the optimal price data for the specific vehicle by applying the formula included in the given pricing rule to the specific vehicle; create the response including the optimal price data for the specific vehicle by the application host; send the response to the browser for display of the optimal price data on the website; and store the response in the application cache for the subsequent requests.

### BRIEF DESCRIPTION OF THE DRAWINGS

FIG. 1 illustrates an exemplary network system for providing real-time delivery of optimal vehicle pricing data.

FIG. 2 illustrates an exemplary embodiment of a method for providing real-time delivery of optimal vehicle pricing data.

FIG. 3 illustrates an exemplary embodiment of a workflow for calculating the optimal vehicle pricing data.

FIG. 4 illustrates an exemplary embodiment of an application of one or more pricing rules to normalized inventory data.

FIG. 5 illustrates a set of example pricing rules.

FIG. 6 illustrates a set of example discounts for age buckets configurable for pricing rules.

FIG. 7 illustrates a computer system according to exemplary embodiments of the present invention.

### DETAILED DESCRIPTION OF SPECIFIC EMBODIMENTS

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment”, “an embodiment”, “an exemplary embodiment”, or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

Embodiments of the present invention provide the real-time delivery of optimal vehicle pricing data using a caching scheme. Exemplary embodiments of a system in accordance with the present invention allows dealers to configure pricing rules with a greater granularity of parameters than existing systems. For example, exemplary embodiments are capable of grouping vehicles in dealer inventories by any combination of parameters, such as vehicle type, year, make, model, and trim. Dealers configure the pricing rules, which are used to calculate the optimal vehicle pricing data. The vehicle pricing data can then be provided to end user in real-time through the dealer website.

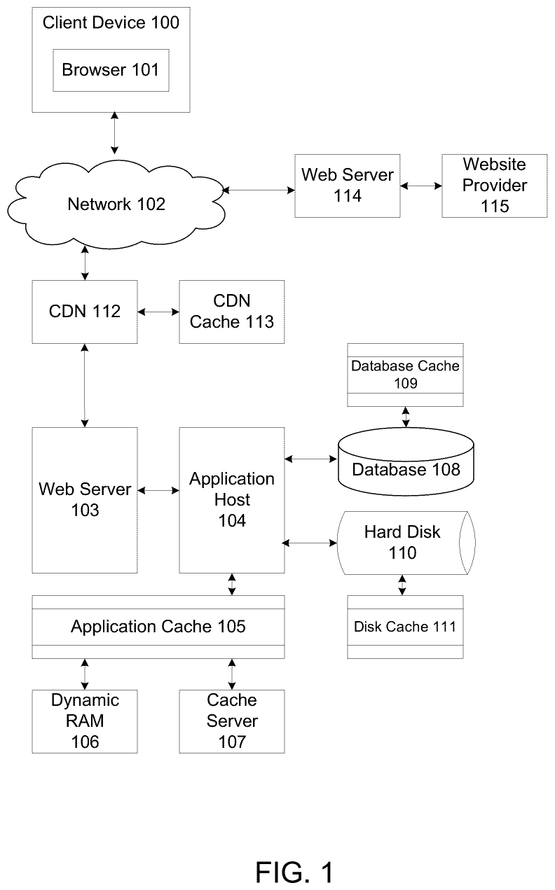

FIG. 1 illustrates an exemplary network system for providing real-time delivery of optimal vehicle pricing data. The network system includes a client device 100 comprising a browser 101 configured to communicate with a “backend” system over a network 102, such as the Internet. The browser 101 is capable of displaying a dealer website, hosted by a web server 114 of a website provider 115. The web server 114 of the website provider 115 communicates with a web server 103 of an application host 104. The application host 104 hosts the business logic or code providing the functionalities described herein. The application host 104 includes an application cache 105, which can be stored locally in-memory via dynamic random access memory (RAM) 106 or on a cache server 107 that runs an in-memory data-structure store. The web server 103 and the application host 104 can be part of the same service or be separate services, depending on the application architecture. The application host 104 is configured with access to a database 108 with a database cache 109 for storing pricing rules configured by an administrator, inventory data, and/or pricing data. Optionally, the application host 104 is further configured with access to a hard disk 110 with a disk cache 111, also capable of storing the data. In one exemplary embodiment, the data can be cached at a distributed system, such as a content delivery network (CDN) 112 including a CDN cache 113, disposed at the network edge, for even faster retrieval.

In an exemplary embodiment, a code snippet is installed on the dealer website by the website provider 115. The code snippet is a reference to a script, e.g., JavaScript™ file, created specifically for a particular dealer website. Upon installation of the code snippet to the dealer website, the script is inserted into an inventory page of the dealer website and executes. The script parses the Document Object Model (DOM) of the inventory page containing the dealer's inventory of vehicles and identifies locations on the webpage to which to add the vehicle pricing data tool. The script modifies the DOM and adds additional HTML tags to the webpage. The HTML tags include an Inline Frame (Iframe), which serves content to the dealer website from the web server 103.

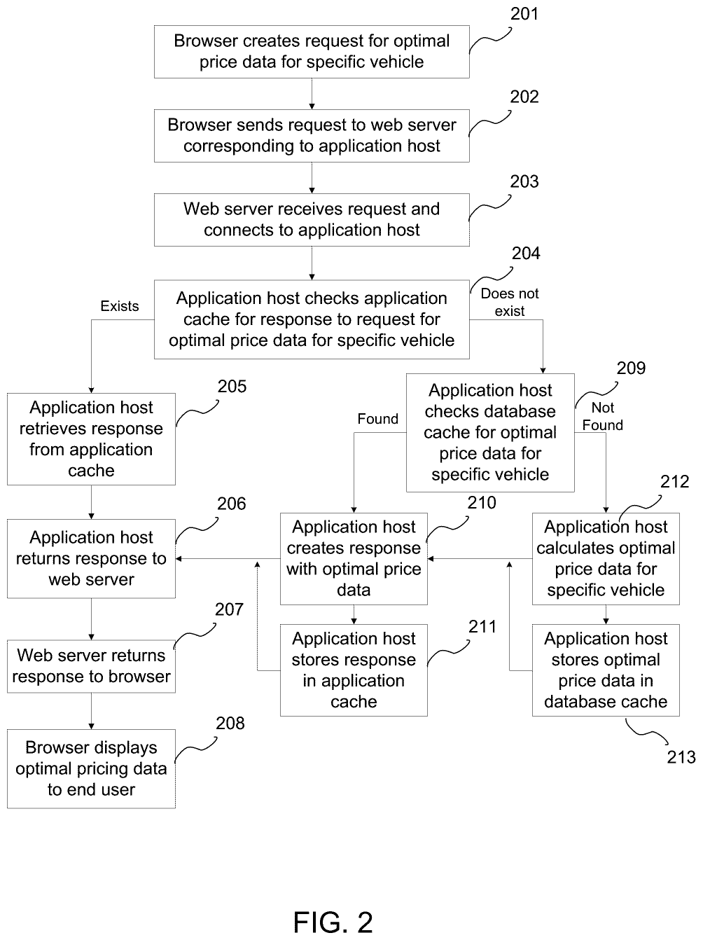

FIG. 2 illustrates an exemplary embodiment of a method for providing real-time delivery of optimal vehicle pricing data. An end user visits a dealer website. In this exemplary embodiment, the “end user” refers to the end consumer or end buyer of a vehicle, not a wholesaler or distributor of the vehicles. In an exemplary embodiment, the dealer website comprises a “button” for the vehicle pricing data tool, the selection of which requests an optimal price for a specific vehicle. As used herein, the “optimal price” includes a price which reflects the highest monetary incentive, the most desirable non-monetary incentives, or a combination of the two. Selection of the button by the end user triggers a fillable form requesting additional information from the end user. Upon submission of the information, the browser 101 creates a request for the optimal price data for the specific vehicle (block 201). The browser 101 sends the request to the web server 103 corresponding to the application host 104 (block 202). The web server 103 receives the request from the browser 101 and, in response, connects to the application host 104 (block 203). The application host 104 checks the application cache 105 for a response to the request for the optimal price data for the specific vehicle (block 204). If the response exists in the application cache 105, the application host 104 retrieves the response from the application cache 105 (block 205) and returns the response to the web server 103 (block 206). The web server 103 returns the response to the browser 101 (207), which then displays the pricing data in the response to the end user (block 208).

If the response does not exist in the application cache 105, the application host 104 checks the database cache 109 for the optimal price data for the specific vehicle (block 209). If the optimal price data is found in the database cache 109, then the application host 104 creates a response with the optimal price data (block 210) and returns the response to the web server 103 (block 206). The application host 104 also stores the response in the application cache 105 (block 211), to be used for subsequent requests for the same optimal price data. If the optimal price data is not found in the database cache 109, then the application host 104 calculates the optimal price data for the specific vehicle (block 212), as described further below. The application host 104 then creates the response with the optimal price data (210) and returns the response to the web server 103 (block 206). The application host 104 also stores the response in the application cache 105 (block 211) and stores the optimal price data in the database cache 109 (block 213), to be used for subsequent requests. Optionally, the calculated optimal price data can be stored on the hard disk 110 and/or in the hard disk cache 111.

In the above manner, the dealer website provides the optimal price data for the specific vehicle to the end user in real-time, or “instantly”, i.e., while the end user is still interacting with the dealer website.

In some embodiments, the application cache 105 is not involved in the real-time delivery of the optimal vehicle pricing data, however, the involvement of the application cache 105 decreases the response time to a request for pricing data.

In some embodiments, the response time is further reduced by the use of the CDN 112. In this case, the request from the browser 101 is sent to the CDN 112. The CDN 112 determines whether the response to the request is stored in the CDN cache 113. If the response is found in the CDN cache 113, the CDN 112 returns the response without the request being forwarded to the web server 103. If the response is not found in the CDN cache 113, the request is forwarded to the web server 103, and blocks 203-213 are performed. When the web server 103 returns the response to the browser 101 (block 207), the response is sent through the CDN 112. The CDN 112 stores a copy of the response and its corresponding request in the CDN cache 113 and forwards the response to the browser 101. The copy of the response in the CDN cache 113 can then be used for subsequent requests.

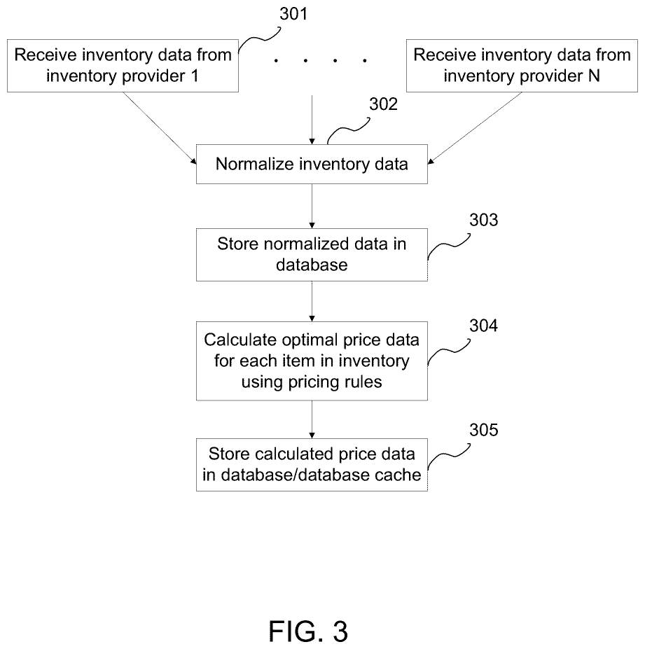

FIG. 3 illustrates an exemplary embodiment of a workflow for calculating the optimal vehicle pricing data. Updated vehicle inventory data is received by the application host 104 from one or more inventory providers (1-N) (block 301). For example, an inventory provider uploads an inventory to the application host 104 daily, such as through a standalone file transfer protocol (FTP) server. This inventory may be in a common-separated values (CSV) format with comma-separated values. The application host 104 parses the inventory data in the CSV file and normalizes the data (block 302). In the normalization, only specific columns are fetched from the CSV file. Further, some columns from the CSV file are transformed to different data types, such as strings to dates, string to Booleans, etc. The normalized inventory data is then stored in the database 108 (block 303). One or more pricing rules are applied to the normalized inventory data to calculate the optimal price data for each item/vehicle in the inventory (block 304), as described further below. The optimal price data can then be stored in the database 108 (block 305). Alternatively, or in combination, the optimal price data can further be stored in the database cache 109, as described above. Recalculations of the optimal price data can be triggered either by the upload of an updated inventory and/or manually by the administrator.

Using a pricing tool implemented by the application host 104, an administrator or account manager of a dealer configures one or more pricing rules used to calculate the optimal pricing data. The pricing rules include two parts: meta data containing parameter values, used to match a rule to vehicle(s) in the inventory; and formulas used for calculating optimal price data for vehicles matching a configured combination of parameters values. In an exemplary embodiment, the parameters include but are not limited to: vehicle type; year; make; model; and trim. An example formula is as follows:

Optimal Price=Base Price±n % of Base Price±OEM Incentives±Age Bucket Discount±Dealer Discount,
where the value of any of the variables can be zero. Here, the Base Price can be represented by any of the following: manufacturer suggested retail price (MSRP); invoice (the actual price that the dealer pays to the manufacturer for a vehicle; sale price/selling price (the price at which the dealer is willing to sell a vehicle); advertising price (price used in different advertising materials); or a custom price set by the dealer. OEM Incentives are financial inducements used by manufacturers to motivate dealers to sell particular vehicles by offering additional specified discounts. Age Bucket is a discount that the dealer sets based on the amount of time a vehicle has been in the dealer's inventory. Dealer Discount is an additional fixed amount discount offered by the dealer. The administrator can configure pricing rules to group vehicles by any combinations of parameter values in a hierarchical manner to realize desired levels of granularity. For example, a first pricing rule can be configured to apply to all new vehicles in the inventory. A second pricing rule can be configured to apply a discount to vehicles of a specific year, which overrides the first pricing rule. A third pricing rule can be configured with a combination of type, year, and make parameter values, which overrides the first and second pricing rules, etc. If a specific vehicle matches the parameters values in multiple rules, then the pricing rule with the most detailed combination of parameters is applied to calculate the optimal price for the specific vehicle.

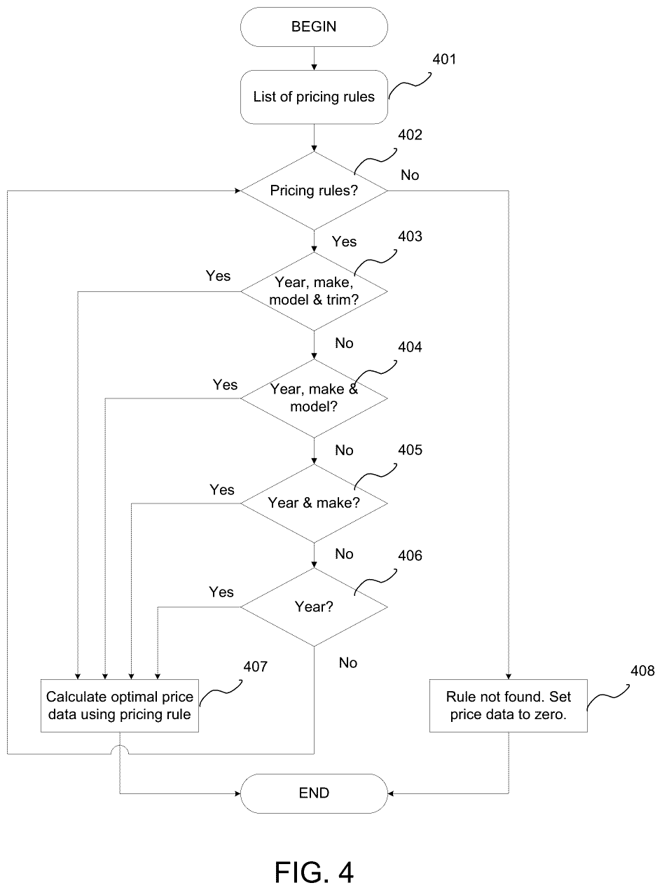

FIG. 4 illustrates an exemplary embodiment of an application of one or more pricing rules to normalized inventory data. The application host 104 extracts the vehicle type of the specific vehicle and identifies a list of pricing rules 401 matching the vehicle type. If none of the pricing rules match the vehicle type (block 402), then the price data for the specific vehicle is set to zero or null (block 408). In this exemplary embodiment, an optimal price of zero/null causes the application host 104 to return a response indicating no optimal price is available. In one exemplary embodiment, a “Call for Price” is displayed by the browser 101 as the response to the request. The application host 104 then iterates over the list of pricing rules 401 to find the pricing rule with the highest number of parameter values matching the vehicle meta data. In other words, the higher the number of matching parameters a pricing rule contains, the higher the priority of the pricing rule. For example, as illustrated in FIG. 4, assume that the pricing rules can include parameters values for year, make, model, and trim. If the vehicle meta data matches all of the parameter values in a first pricing rule (block 403), configured with the combination of year, make, model, and trim parameters values, then the application host 104 applies the formula in the first pricing rule to calculate the optimal price data for the vehicle (block 407). Pricing rules of lesser granularity of parameters than the first pricing rule are not applied.

If the vehicle meta data does not match all of the parameter values in the first pricing rule, but matches the parameter values in a second pricing rule (block 404), configured with a combination of year, make, and model parameter values, then the application host 104 applies the formula in the second pricing rule to calculate the optimal price data for the vehicle (block 407). Pricing rules of lesser granularity of parameters than the second pricing rule are not applied.

If the vehicle meta data does not match all of the parameter values in the first or second pricing rules, but matches the parameter values in a third pricing rule (block 405), configured with a combination of year and make parameter values, then the application host 104 applies the formula in the third pricing rule to calculate the optimal price data for the vehicle (block 407). Pricing rules of lesser granularity of parameters than the third pricing rule are not applied.

If the vehicle does not match all of the parameter values in the first, second, or third pricing rules, but matches the parameter value in a fourth pricing rule (block 406), configured with a year parameter value), then the application host 104 applies the formula in the fourth pricing rule to calculate the optimal price data for the given vehicle (block 407).

The above process is repeated for other vehicles in the database 108. The calculated optimal price data for each vehicle is stored in the database 108 or hard disk 110, or in the database cache 109 or disk cache 111, as described above with reference to FIG. 1. The optimal price data can then be used to create a response to a request from the browser 101, as described above.

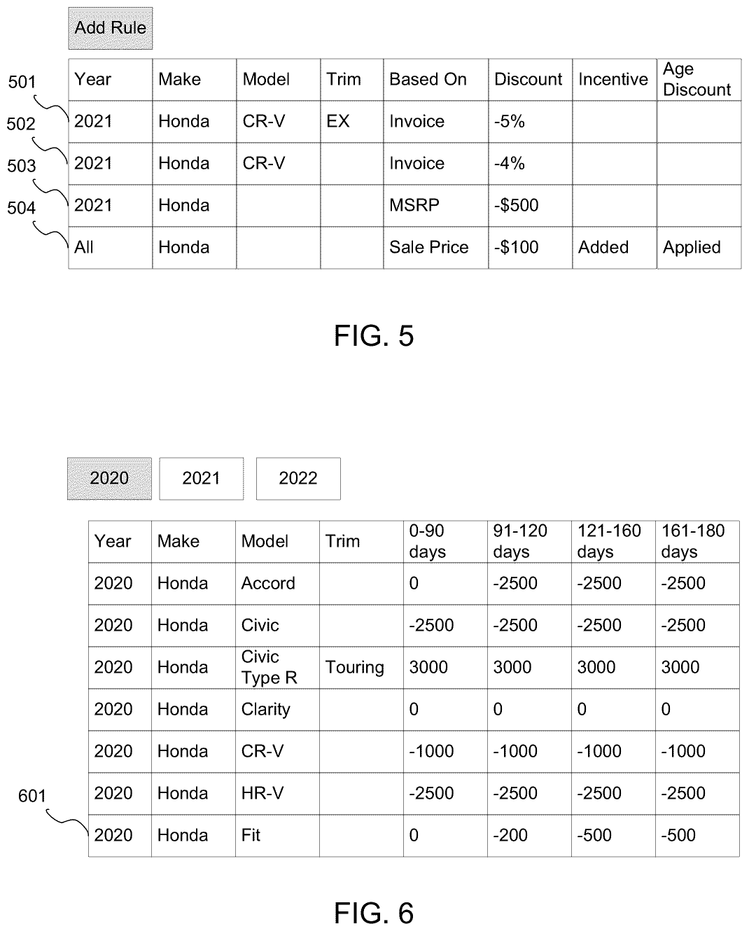

FIG. 5 illustrates a set of example pricing rules. In this example, a first pricing rule 501 is configured to apply a 5% discount to the invoice for vehicles matching a Year=2021, Make=Honda, Model=CR-V, and Trim=EX. A second pricing rule 502 is configured to apply a 4% discount to the invoice for vehicles matching a Year=2021, Make=Honda, and Model=CR-V. A third pricing rule 503 is configured to apply a $500 discount to the MSRP for vehicles matching a Year=2021 and make=Honda. A fourth pricing rule 504 is configured to apply a $100 incentive, a corresponding incentive to the sale price, and an age discount for all Honda vehicles. Thus, for each 2021 Honda CR-V EX in the database 108, pricing rule 501 is applied to calculate its optimal price, and pricing rules 502-504 are not applied since they are of lesser granularity of parameters and thus have less priority than pricing rule 501. Similarly, for each 2021 Honda CR-V in the database 108 that does not have an EX trim, pricing rule 502 is applied to calculate its optimal price, and pricing rules 501, 503 and 504 are not applied. For each 2021 Honda vehicle that is not a CR-V, pricing rule 503 is applied to calculate its optimal price, but pricing rules 501, 502, and 504 are not applied. For any Honda vehicle that does not match the Year, Model or Trim parameters in the other pricing rules 501-503, pricing rule 504 is applied to calculate its optimal price. In this example, only Year, Make, Model and Trim parameters are demonstrated. However, other parameters may also be used. Further, this example only illustrates a discount, an incentive, and an age discount variables in the formula, but other variables can also be used. Different age discounts can be configured for vehicles in different age buckets, as described further below.

When a new vehicle is delivered to the dealer, typically the dealer assigns the vehicle a specific stock number. The vehicle then begins to “age”. In an exemplary embodiment, the dealer can assign different age discounts for different time intervals a vehicle stays in its inventory. The ability to configure different age discounts for different age buckets assists the dealer in keeping the vehicle inventory rotated, since the more a vehicle stays in the inventory, the less likely the dealer will receive an incentive from the manufacturer. FIG. 6 illustrates a set of example age discounts for age buckets configurable for pricing rules. The example includes age buckets 601 configured for 2020 Honda Fit vehicles. No age discount is applied for these vehicles in the 0-90 days age bucket, an $200 age discount is applied for those in the 91-120 days age bucket, and a $500 age discount is applied for those in the 121-160 days and 161-180 days age buckets. Thus, combining the examples in FIGS. 5 and 6, pricing rule 504 is applied to each 2020 Honda Fit vehicles, and the age discount corresponding to the age bucket 601 is applied through the calculation of the optimal price according to the pricing rule 504.

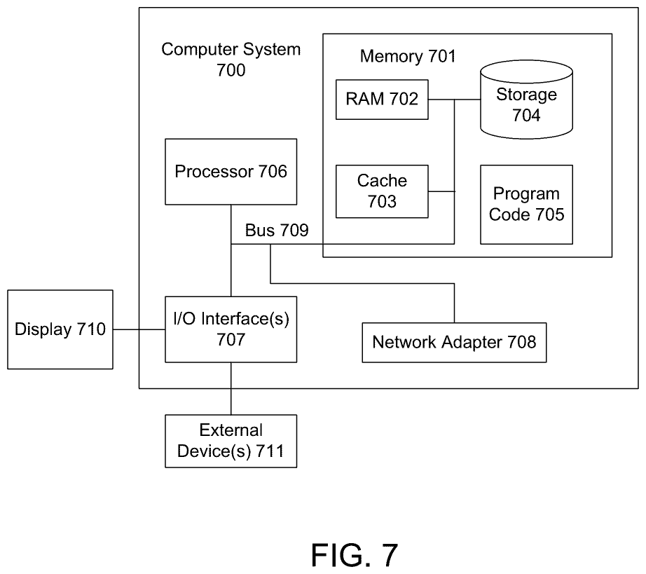

FIG. 7 illustrates a computer system according to exemplary embodiments of the present invention. One or more computer systems 700 implements any combination of computing devices in the network system illustrated in FIG. 1. The computer system 700 is operationally coupled to a processor or processing units 706, a memory 701, and a bus 709 that couples various system components, including the memory 701 to the processor 706. The bus 709 represents one or more of any of several types of bus structure, including a memory bus or memory controller, a peripheral bus, an accelerated graphics port, and a processor or local bus using any of a variety of bus architectures. The memory 701 may include computer readable media in the form of volatile memory, such as random access memory (RAM) 702 or cache memory 703, or non-volatile storage media 704. The memory 701 may include at least one program product having a set of at least one program code module 705 that are configured to carry out the functions of embodiment of the present invention when executed by the processor 706. The computer system 700 may also communicate with one or more external devices 711, such as a display 710, via I/O interfaces 707. The computer system 700 may communicate with one or more networks via network adapter 708.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer usable or computer readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for real-time delivery of vehicle data, comprising:
receiving, by an application host, from a browser displaying a website for a dealer of a plurality of vehicles, a request for vehicle data for a specific vehicle to be displayed on the website, the vehicle data comprising optimal price data for the specific vehicle;
determining, by the application host, whether a response comprising the optimal price data for the specific vehicle exists in an application cache;
in response to determining that the response exists in the application cache, retrieving the response from the application cache by the application host and sending the response to the browser for display of the optimal price data on the website;
in response to determining that the response does not exist in the application cache, determining whether the optimal price data for the specific vehicle exists in a database cache of a database storing meta data for the plurality of vehicles;
in response to determining that the optimal price data for the specific vehicle exists in the database cache, retrieving the optimal price data from the database cache by the application host, creating the response with the optimal price data, sending the response to the browser for display of the optimal price data on the website, and storing the response in the application cache for subsequent requests; and
in response to determining that the optimal price data does not exist in the database cache:
determining that meta data for the specific vehicle fails to match all parameter values comprised in at least one of a plurality of pricing rules configured by the dealer, wherein each pricing rule further comprises a formula for calculating a price;
determining whether the meta data for the specific vehicle matches less than all of the parameter values comprised in the plurality of the pricing rules; and
in response to determining that the meta data for the specific vehicle matches less than all of the parameter values comprised in at least one of the plurality of pricing rules:
identifying a given pricing rule of the plurality of pricing rules that comprises a highest number of parameter values matching the meta data for the specific vehicle;
calculating the optimal price data for the specific vehicle by applying the formula comprised in the given pricing rule to the specific vehicle;
creating the response comprising the optimal price data for the specific vehicle by the application host;
sending the response to the browser for display of the optimal price data on the website; and
storing the response in the application cache for the subsequent requests.

2. The method of claim 1, wherein the one or more parameter values comprises one or more of the following: a year of a vehicle; a make of the vehicle; a model of the vehicle; a trim of the vehicle; a vehicle type; and an age representing a time in which the vehicle has been in an inventory of the dealer.

3. The method of claim 1, wherein the formula comprises one or more variables comprising one or more of the following: a manufacturer suggested retail price (MSRP); an invoice; a vehicle price; an age discount; a fixed value discount; and an incentive.

4. The method of claim 1, wherein in response to determining that the meta data for the specific vehicle does not match the parameter values comprised in any of the plurality of pricing rules, returning, by the application host, to the browser, an indication that no optimal price data is available for the specific vehicle.

5. The method of claim 1, wherein prior to the receiving of the request by the application host, the method further comprises:
receiving, by a content delivery network (CDN), the request for the optimal price data for the specific vehicle from the browser;
determining, by the CDN, whether the response exists in a CDN cache;
in response to determining that the response exists in the CDN cache, returning the response in the CDN cache to the browser without forwarding the request to a web server;
in response to determining that the response does not exist in the CDN cache, forwarding the request to the web server by the CDN;
in response to receiving the request from the CDN by the web server:
connecting to the application host by the web server;
receiving the response to the request by the web server from the application host; and
sending the response to the browser by the web server for display of the optimal price data on the website.

6. A non-transitory computer readable medium comprising computer readable program code embodied therein, wherein when executed by a processor causes the processor to:
receive, from a browser displaying a website for a dealer of a plurality of vehicles, a request for vehicle data for a specific vehicle to be displayed on the website, the vehicle data comprising optimal price data for the specific vehicle;
determine whether a response comprising the optimal price data for the specific vehicle exists in an application cache;
in response to determining that the response exists in the application cache, retrieve the response from the application cache and send the response to the browser for display of the optimal data on the website;
in response to determining that the response does not exist in the application cache, determine whether the optimal price data for the specific vehicle exists in a database storing meta data for the plurality of vehicles;
in response to determining that the optimal price data for the specific vehicle exists in the database cache, retrieve the optimal price data from the database cache, create the response with the optimal price data, send the response to the browser for display of the optimal price data on the website, and store the response in the application cache for subsequent requests; and
in response to determining that the optimal price data does not exist in the database cache:
determine that meta data for the specific vehicle fails to match all parameter values comprised in at least one of a plurality of pricing rules, wherein each pricing rule further comprises a formula for calculating a price;
determine whether the meta data for the specific vehicle matches less than all of the parameter values comprised in the plurality of the pricing rules; and
in response to determining that the meta data for the specific vehicle matches less than all of the parameter values comprised in at least one of the plurality of pricing rules:
identify a given pricing rule of the plurality of pricing rules that comprises a highest number of parameter values matching the meta data for the specific vehicle;
calculate the optimal price data for the specific vehicle by applying the formula comprised in the given pricing rule to the specific vehicle;
create the response comprising the optimal price data for the specific vehicle by the application host;
send the response to the browser for display of the optimal price data on the website; and
store the response in the application cache for the subsequent requests.

7. The medium of claim 6, wherein the one or more parameter values comprises one or more of the following: a year of a vehicle; a make of the vehicle; a model of the vehicle; a trim of the vehicle; a vehicle type; and an age representing a time in which the vehicle has been in an inventory of the dealer.

8. The medium of claim 6, wherein the formula comprises one or more variables comprising one or more of the following: a manufacturer suggested retail price (MSRP); an invoice; a sale price; an age discount; a fixed value discount; and an incentive.

9. The medium of claim 6, wherein in response to determining that the meta data for the specific vehicle does not match the parameter values comprised in any of the plurality of pricing rules, return, to the browser, an indication that no optimal price data is available for the specific vehicle.

10. The medium of claim 6, wherein prior to the receiving of the request by the application host, the processor is caused to:
cause receipt by a content delivery network (CDN) of the request for the optimal price data for the specific vehicle from the browser;
cause a determination by the CDN of whether the response exists in a CDN cache;
cause, in response to determining that the response exists in the CDN cache, a return of the response in the CDN cache to the browser without forwarding the request to a web server;
cause, in response to determining that the response does not exist in the CDN cache, a forwarding of the request to the web server by the CDN;
cause, in response to receiving the request from the CDN by the web server:
a connection to the application host by the web server;
receipt of the response to the request by the web server from the application host; and
a sending of the response to the browser by the web server for display of the optimal price data on the website.

11. A system, comprising:
an application host comprising a processor, an application cache, and a non-transitory computer readable medium comprising computer readable program code embodied therein, wherein when executed by the processor causes the processor to:
receive, from a browser displaying a website for a dealer of a plurality of vehicles, a request for vehicle data for a specific vehicle to be displayed on the website, the vehicle data comprising optimal price data for the specific vehicle;
determine whether a response comprising the optimal price data for the specific vehicle exists in an application cache;
in response to determining that the response exists in the application cache, retrieve the response from the application cache and send the response to the browser for display of the optimal data on the website;
in response to determining that the response does not exist in the application cache, determine whether the optimal price data for the specific vehicle exists in a database cache of a database storing meta data for the plurality of vehicles;
in response to determining that the optimal price data for the specific vehicle exists in the database cache, retrieve the optimal price data from the database cache, create the response with the optimal price data, send the response to the browser for display of the optimal price data on the website, and store the response in the application cache for subsequent requests; and
in response to determining that the optimal price data does not exist in the database cache:
determine that meta data for the specific vehicle fails to match all parameter values comprised in at least one of a plurality of pricing rules, wherein each pricing rule further comprises a formula for calculating a price;
determine whether the meta data for the specific vehicle matches less than all of the parameter values comprised in the plurality of the pricing rules; and
identify a given pricing rule of the plurality of pricing rules that comprises a highest number of parameter values matching the meta data for the specific vehicle;
in response to determining that the meta data for the specific vehicle matches less than all of the parameter values comprised in at least one of the plurality of pricing rules:
calculate the optimal price data for the specific vehicle by applying the formula comprised in the given pricing rule to the specific vehicle;
create the response comprising the optimal price data for the specific vehicle by the application host;
send the response to the browser for display of the optimal price data on the website; and
store the response in the application cache for the subsequent requests.

12. The system of claim 11, wherein the one or more parameter values comprises one or more of the following: a year of a vehicle; a make of the vehicle; a model of the vehicle; a trim of the vehicle; a vehicle type; and an age representing a time in which the vehicle has been in an inventory of the dealer.

13. The system of claim 11, wherein the formula comprises one or more variables comprising one or more of the following: a manufacturer suggested retail price (MSRP); an invoice; a vehicle price; an age discount; a fixed value discount; and an incentive.

14. The system of claim 11, wherein in response to determining that the meta data for the specific vehicle does not match the parameter values comprised in any of the plurality of pricing rules, return, to the browser, an indication that no optimal price data is available for the specific vehicle.

15. The system of claim 11, further comprising a web server and a content delivery network (CDN) comprising a CDN cache, wherein prior to the receiving of the request by the application host, the processor is caused to:
cause receipt by the CDN of the request for the optimal price data for the specific vehicle from the browser;
cause a determination by the CDN of whether the response exists in the CDN cache;
cause, in response to determining that the response exists in the CDN cache, a return of the response in the CDN cache to the browser without forwarding the request to the web server;
cause, in response to determining that the response does not exist in the CDN cache, a forwarding of the request to the web server by the CDN;
cause, in response to receiving the request from the CDN by the web server:
a connection to the application host by the web server;
receipt of the response to the request by the web server from the application host; and
cause a sending of the response to the browser by the web server for display of the optimal price data on the website.
